(19) United States
(12) Patent Application Publication
(10) Pub. No.: US 2020/0131717 A1
(43) Pub. Date: Apr. 30, 2020

(54) PAVER AND METHODS FOR MANUFACTURING AND USING SAME

(71) Applicant: PAVER TECHNOLOGIES LLC, Vero Beach, FL (US)

(72) Inventor: William Eliason, Vero Beach, FL (US)

(21) Appl. No.: 16/176,123

(22) Filed: Oct. 31, 2018

(51) Int. Cl. E01C 5/00; E01C 5/06; E01C 5/04; E01C 19/52

(52) U.S. Cl. CPC E01C 5/00; E01C 5/06; E01C 5/04; B28B 1/14; E01C 5/001; E01C 2201/00; E01C 19/52

(57) ABSTRACT

The disclosed technology includes a paver including a gripping structure on the bottom surface thereof, as well as methods for manufacturing and using the same.

### BACKGROUND

Pavers, such as paver stones, paver bricks, or paver tiles, are commonly used to create flooring, such as exterior flooring. Typically, each paver includes a substantially flat top surface and a substantially flat bottom surface, and multiple pavers are set or adhered to a foundation to create a desired flooring effect. But existing pavers may be susceptible to slippage during or after the construction process. For example, if an adhesive is not used, existing pavers may slip or slide on the foundation during construction, which may require additional measures to hold the pavers in place. Alternately or in addition, pavers installed without adhesive may initially remain in the correct position but may shift out of position over time. Such movement may be caused or accelerated due to use of the flooring, such as pedestrians walking on the flooring or vehicles driving on the flooring. Further, even if an adhesive is used to affix the pavers to the foundation, existing pavers may still be susceptible to slippage during or after the construction process. For example, existing pavers may slip during construction if the adhesive is of an incorrect viscosity and/or if the foundation is not flat.

### SUMMARY

These and other problems may be addressed by embodiments of the technology disclosed herein. Certain embodiments include a paver having one or more gripping structures on the bottom surface of the paver so as to facilitate secure placement of the paver during and after construction. In some embodiments, the gripping structures may include one or more protrusions. In some embodiments, the gripping structures may include one or more recesses. In some embodiments, the gripping structures may include one or more protrusions and one or more recesses.

### BRIEF DESCRIPTION OF THE FIGURES

Reference will now be made to the accompanying figures, which are not necessarily drawn to scale, and wherein:

FIGS. 1a-1c depict a paver, according to certain embodiments of the present disclosure, with FIG. 1a showing a perspective view thereof, FIG. 1b showing a top view thereof, and FIG. 1c showing a side view thereof;

FIGS. 2a-2c depict a paver, according to certain embodiments of the present disclosure, with FIG. 2a showing a perspective view thereof, FIG. 2b showing a top view thereof, and FIG. 2c showing a side view thereof;

FIGS. 3a-3c depict a paver, according to certain embodiments of the present disclosure, with FIG. 3a showing a perspective view thereof, FIG. 3b showing a top view thereof, and FIG. 3c showing a side view thereof;

FIGS. 4a-4c depict a paver, according to certain embodiments of the present disclosure, with FIG. 4a showing a perspective view thereof, FIG. 4b showing a top view thereof, and FIG. 4c showing a side view thereof;

FIGS. 5a-5c depict a paver, according to certain embodiments of the present disclosure, with FIG. 5a showing a perspective view thereof, FIG. 5b showing a top view thereof, and FIG. 5c showing a side view thereof;

FIGS. 6a-6c depict a paver, according to certain embodiments of the present disclosure, with FIG. 6a showing a perspective view thereof, FIG. 6b showing a top view thereof, and FIG. 6c showing a side view thereof;

FIGS. 7a-7c depict a paver, according to certain embodiments of the present disclosure, with FIG. 7a showing a perspective view thereof, FIG. 7b showing a top view thereof, and FIG. 7c showing a side view thereof;

FIGS. 8a-8c depict a paver, according to certain embodiments of the present disclosure, with FIG. 8a showing a perspective view thereof, FIG. 8b showing a top view thereof, and FIG. 8c showing a side view thereof;

FIGS. 9a-9c depict a paver, according to certain embodiments of the present disclosure, with FIG. 9a showing a perspective view thereof, FIG. 9b showing a top view thereof, and FIG. 9c showing a side view thereof;

FIGS. 10a-10c depict a paver, according to certain embodiments of the present disclosure, with FIG. 10a showing a perspective view thereof, FIG. 10b showing a top view thereof, and FIG. 10c showing a side view thereof; and

FIGS. 11a-11c depict a paver, according to certain embodiments of the present disclosure, with FIG. 11a showing a perspective view thereof, FIG. 11b showing a top view thereof, and FIG. 11c showing a side view thereof.

FIGS. 12a-12c depict a paver, according to certain embodiments of the present disclosure, with FIG. 12a showing a perspective view thereof, FIG. 12b showing a top view thereof, and FIG. 12c showing a side view thereof.

FIGS. 13a-13d depict a paver, according to certain embodiments of the present disclosure, with FIG. 13a showing a perspective view thereof, FIG. 13b showing a top view thereof, FIG. 13c showing a side view thereof, and FIG. 13d showing an end view thereof.

FIGS. 14a-14d depict a paver, according to certain embodiments of the present disclosure, with FIG. 14a showing a perspective view thereof, FIG. 14b showing a top view thereof, FIG. 14c showing a side view thereof, and FIG. 14d showing an end view thereof.

FIGS. 15a-15c depict a paver, according to certain embodiments of the present disclosure, with FIG. 15a showing a perspective view thereof, FIG. 15b showing a top view thereof, and FIG. 15c showing a side view thereof.

FIGS. 16a-16c depict a paver, according to certain embodiments of the present disclosure, with FIG. 16a showing a perspective view thereof, FIG. 16b showing a top view thereof, and FIG. 16c showing a side view thereof.

FIGS. 17a-17c depict a paver, according to certain embodiments of the present disclosure, with FIG. 17a showing a perspective view thereof, FIG. 17b showing a top view thereof, and FIG. 17c showing a side view thereof.

FIGS. 18a-18c depict a paver, according to certain embodiments of the present disclosure, with FIG. 18a showing a perspective view thereof, FIG. 18b showing a top view thereof, and FIG. 18c showing a side view thereof.

### DETAILED DESCRIPTION

Throughout this disclosure, certain example embodiments are described in relation to pavers. But embodiments of the disclosed technology are not so limited. In some embodiments, the disclosed technology may be effective for providing a secure exterior edge for an area to be paved such that an interior portion of the area can be paved, such as with traditional pavers.

Some embodiments of the disclosed technology will be described more fully hereinafter with reference to the accompanying drawings. This disclosed technology may, however, be embodied in many different forms and should not be construed as limited to the embodiments set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

According to some embodiments, the disclosed technology relates to a paver (e.g., paver stone, paver brick, paver tile) including a gripping structure to secure the paver on a foundation, such as a concrete foundation, pavement foundation, a foundation of packed earth, or a foundation of any other material. In some embodiments, the paver may include a top surface, a bottom surface, and one or more side surfaces. In some embodiments, the top surface may be substantially flat. In some embodiments, the bottom surface may be substantially flat. In some embodiments, one or more gripping structures is positioned on the bottom surface of the paver. In some embodiments, the gripping structures are integral with the paver. In some embodiments, the gripping structures are permanently attached or affixed to the paver. In some embodiments, a gripping structure may comprise a protrusion. Thus, in some embodiments, the bottom surface may include a plurality of protrusions, and each protrusion may have a substantially equal height with respect to the bottom surface. In certain embodiments, some protrusions may have a height that is different from the height of other protrusions. In some embodiments, a protrusion may have a substantially constant height. In some embodiments, a protrusion may have a height that is not constant. For example, a protrusion may have a height that increases as the distance from the outer edge of the protrusion increases.

In certain embodiments, a gripping structure may comprise a recess. Thus, in some embodiments, the bottom surface may include a plurality of recesses, and each recess may have a substantially equal depth with respect to the bottom surface. In certain embodiments, some recesses may have a depth that is different from the depth of other recesses. In some embodiments, a recess may have a substantially constant depth. In some embodiments, a recess may have a depth that is not constant. For example, a recess may have a depth that increases as the distance from the outer edge of the recess increases. In some embodiments, one or more gripping structures may each comprise a protrusion and one or more gripping structures may each comprise a recess such that the bottom surface may include a combination of one or more protrusions and one or more recesses.

A gripping structure (e.g., a protrusion or recess) can be of any shape, size, orientation, or position on the bottom surface of the paver. In some embodiments, a gripping structure can have a cross-section in the shape of a circle, triangle, square, rectangle, trapezoid, parallelogram, pentagon, hexagon, heptagon, octagon, or any other polygon. In some embodiments, a gripping structure can have a cross-section of an irregular shape. In some embodiments, a gripping structure can have a cross-section of a star, a ring, a spiral, or any other desired shape. In some embodiments, a gripping structure can have a cross-section indicative of a silhouette of a person, character, animal, plant, or other object. For example, a gripping structure can have a cross-section indicative of a silhouette of a mustache, a snowman, a horse, or any other person, animal, plant, or object. In some embodiments, a gripping structure can have a cross-section indicative of a logo, such as a company logo. In some embodiments, a gripping structure can have a cross-section indicative of text, such as a company name.

According to some embodiments, a gripping structure can have a substantially hemispherical shape or a substantially conical shape. In some embodiments, one or more gripping structures can have a shape that is substantially shaped like a pyramid, a spike, a bump, a square or rectangular pillar, a circular pillar, a triangle, or any other shape.

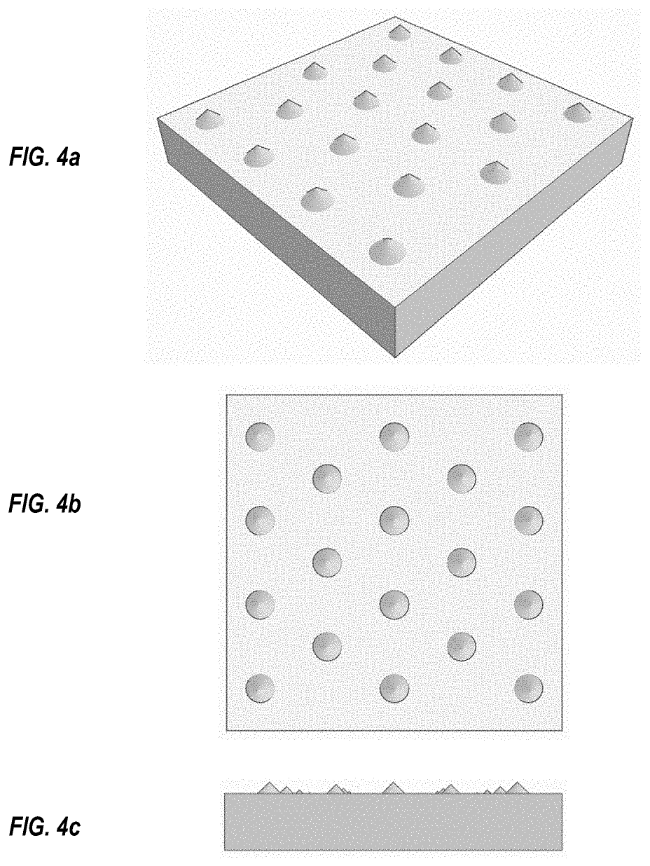

In some embodiments, a plurality of gripping structures can be positioned in any arrangement. For example, in some embodiments, multiple gripping structures may be arranged in a grid formation. In certain embodiments, multiple gripping structures may be arranged in an offset grid formation. For example, in some embodiments, a first, third, and fifth row of gripping structures may be aligned according to a first grid formation, and a second and fourth row of gripping structures may be aligned according to a second grid formation that is offset from the first grid formation. An example of an offset grid formation is depicted in FIGS. 4a-4c, as discussed below. In some embodiments, each of the gripping structures may be positioned equidistantly with respect to one another and/or with respect to the edges of the bottom surface of the paver. In some embodiments, one, some, or all of the gripping structures may be located at positions that are not equidistant.

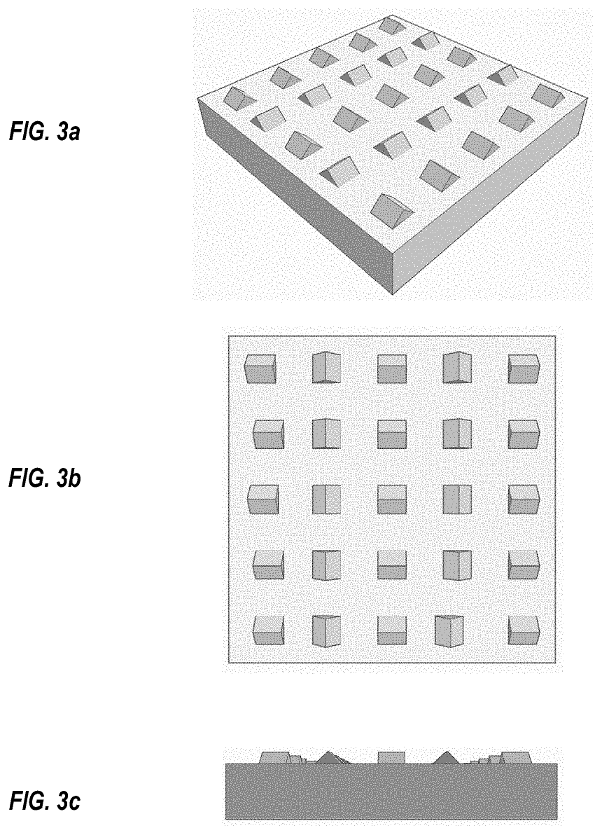

According to some embodiments, gripping structures can be positioned on the bottom surface of a paver in differing orientations. For example, a paver may include first and second gripping structures, and the second gripping structure may be rotated with respect to the first gripping structure. As non-limiting examples, in some embodiments, the second gripping structure may be rotated 10°, 15°, 20°, 30°, 45°, 60°, 90°, or 180° with respect to the first gripping structure. Example paver tiles including gripping structures of differing orientations are depicted in FIGS. 3a-3c, 9a-9c, and 11a-11c, as discussed below.

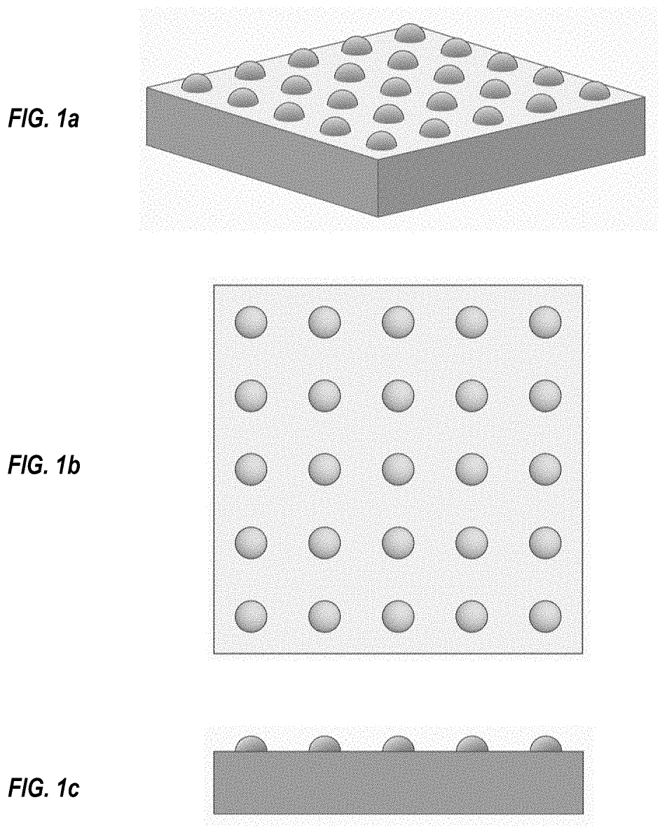

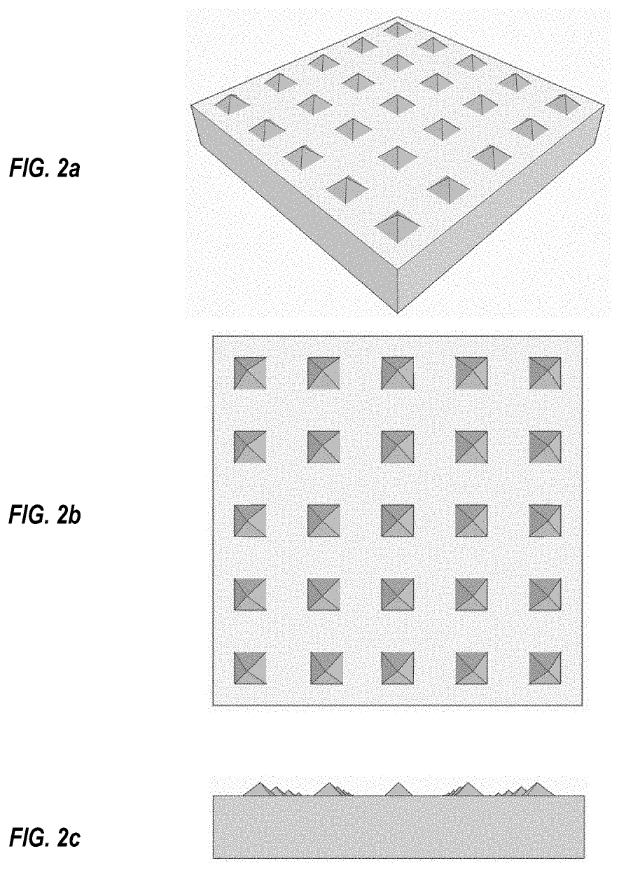

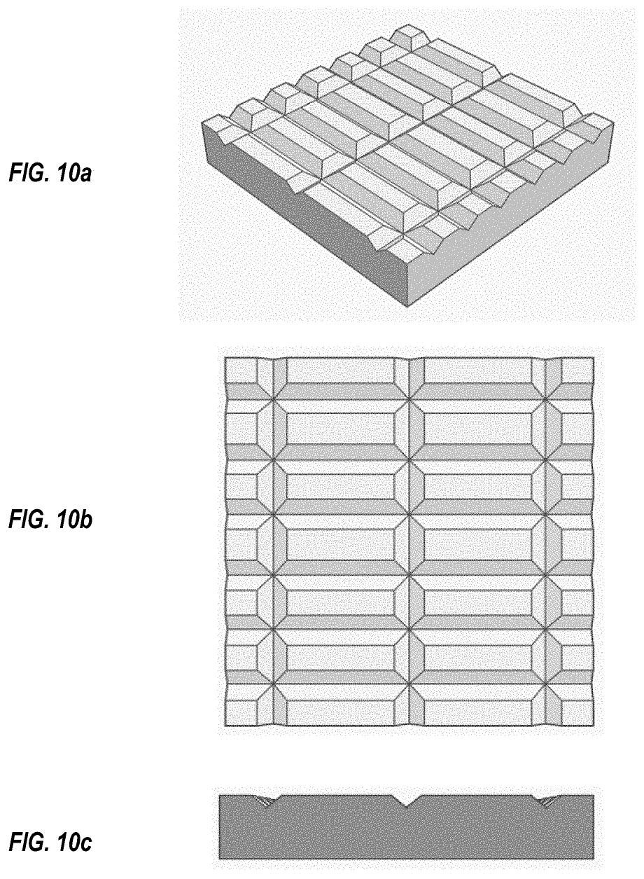

FIGS. 1a-18c depict various example embodiments of pavers including one or more protruding gripping structures (e.g., protrusions) on the bottom surface of the paver and/or one or more recessed gripping structures (e.g., recesses) on the bottom surface of the paver. More specifically, FIGS. 1a-1c depict a grid arrangement of hemispherical protrusions, and FIGS. 2a-2c depict a grid arrangement of square pyramid protrusions.

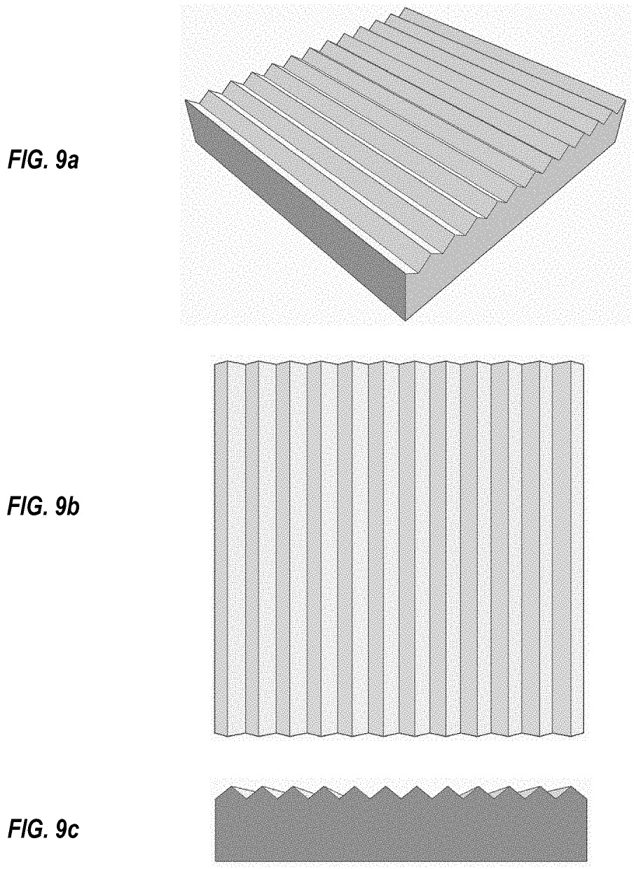

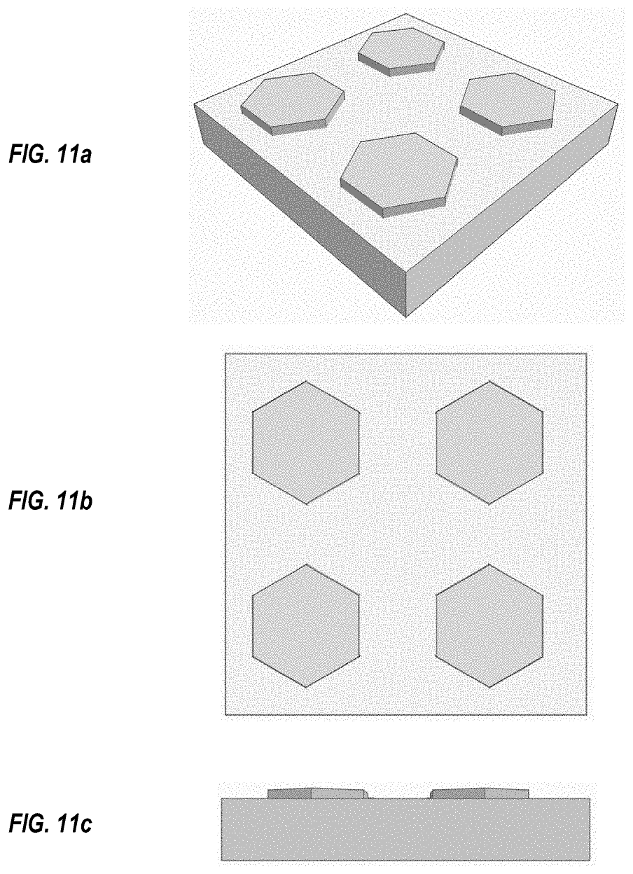

FIGS. 3a-3c depict a grid arrangement of triangular, tent-shaped protrusions having differing orientations. Referring to FIG. 3b, the first, third, and fifth columns include protrusions in a first orientation where the top-most ridge of each protrusion is substantially horizontal, while the second and fourth columns include protrusion in a second orientation where the top-most ridge of each protrusion is substantially vertical. While FIGS. 3a-3c show columns of protrusions sharing the same orientation, embodiments of the disclosed technology are not so limited. In some embodiments, one, some, or every gripping structure may have a distinct orientation with respect to other gripping structures. For example, FIGS. 9a-9c depict an embodiment including two gripping structures, which are mirrors of one another. That is, one gripping structure is has an orientation that is rotated 180° with respect to the other gripping structure. As another example, FIGS. 11a-11c depict an embodiment including four gripping structures, with each gripping structure being rotated 90° with respect to either adjacent gripping structure.

FIGS. 4a-4c depict an offset grid arrangement of conical protrusions. Referring to FIG. 4b, the first, third, and fifth columns include protrusions arranged in a first grid, and the second and fourth columns include protrusion arranged in a second grid such that the protrusions of the second and fourth columns are offset from the protrusions of the first, third, and fifth columns. While FIGS. 4a-4c depict an embodiment including two grids offset with respect to one another, various embodiments may include any number of offset grids, such as three, four, five, or more. Further, FIGS. 4a-4c include multiple groups (e.g., columns) of gripping structures sharing the same grid, but various embodiments are not so limited. Instead, some embodiments may include as few as one single gripping structure that is offset from other gripping structures.

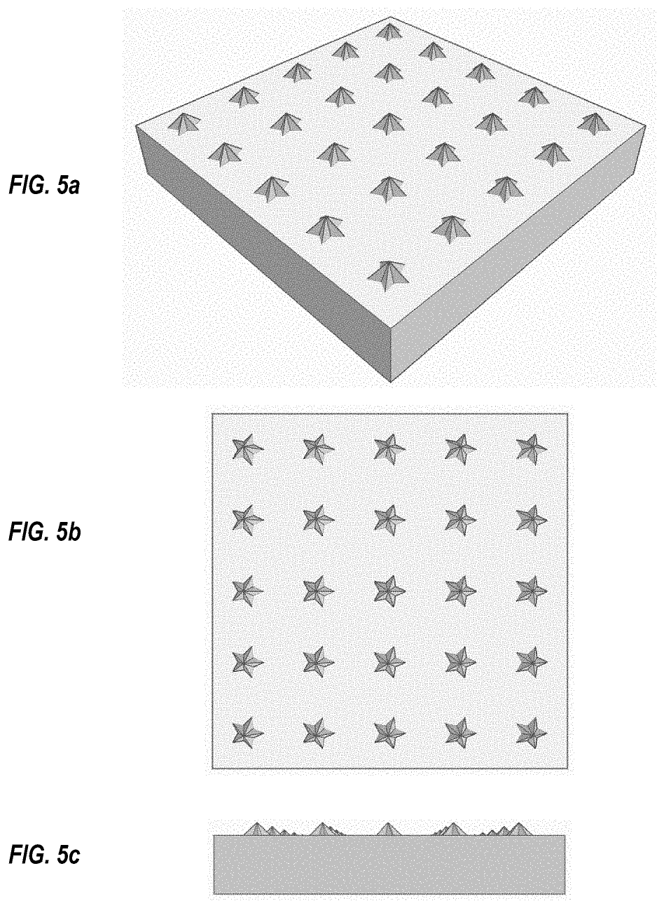

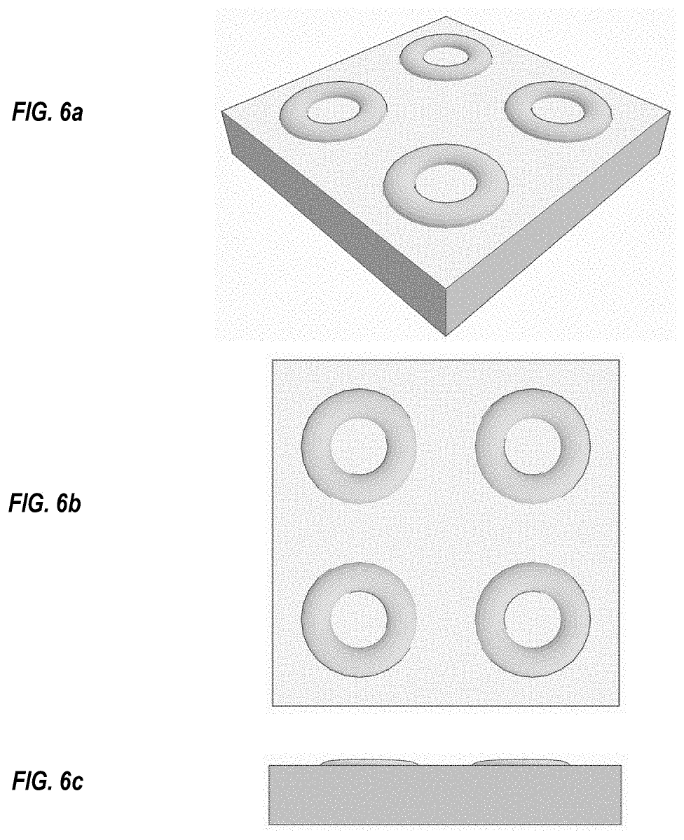

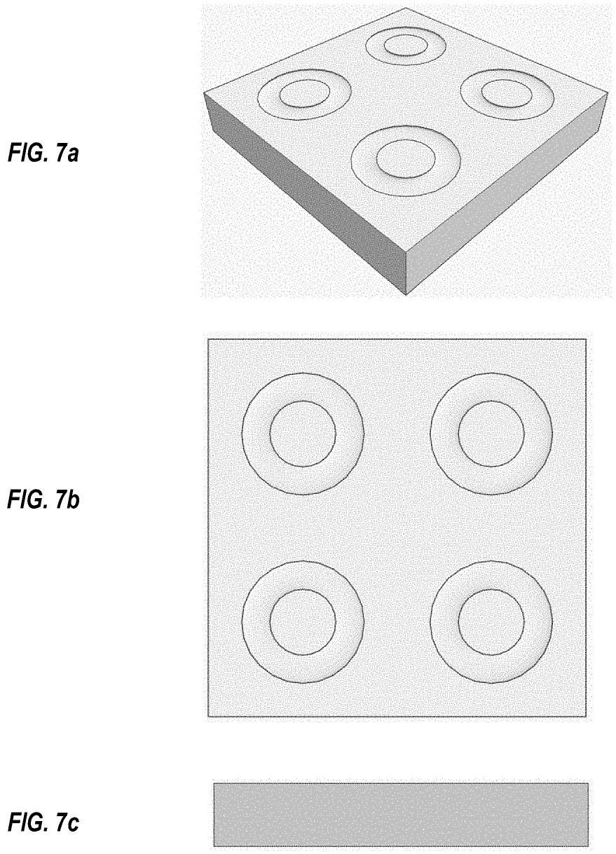

FIGS. 5a-5c depict a grid of star-shaped protrusions. Each protrusion has a non-constant height. As depicted, each protrusion has a sloped height that increases toward the center of the protrusion. But not all embodiments are so limited. For example, some embodiments may include one or more protrusions that has a height that decreases toward the center of the protrusion. Some embodiments may have a height that increases toward the center of the protrusion until a maximum height is reached, and the height may then decrease toward to the outer edge of the protrusion. For example, FIGS. 6a-6c depict an embodiment including ring-shaped protrusions where the inner and outer edges of the ring each have a height that is substantially less than the height of ring between the inner and outer edges. Conversely, some embodiments may include one or more recesses that has a depth that increases toward the center of the recess, and in some embodiments, the depth of the recess may increase toward the center of the protrusion until a maximum depth is reached, and the depth may then decrease toward the outer edge of the recess. For example, FIGS. 7a-7c depict an embodiment including ring-shaped recesses where the inner and outer edges of the ring each have a depth that is substantially less than the depth of ring between the inner and outer edges.

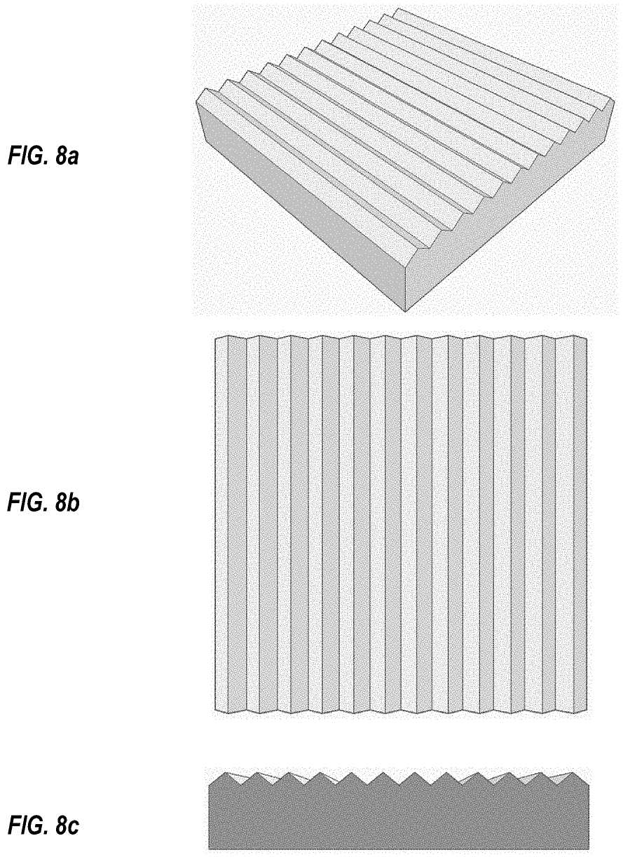

In some embodiments, one or more protrusions and/or one or more recesses may extend across the entire width or the entire length of the paver, such as the embodiments depicted in FIGS. 8a-8c, 9a-9c, and 10a-10c. In some embodiments, one or more protrusions or recesses may extend diagonally across the bottom of the paver.

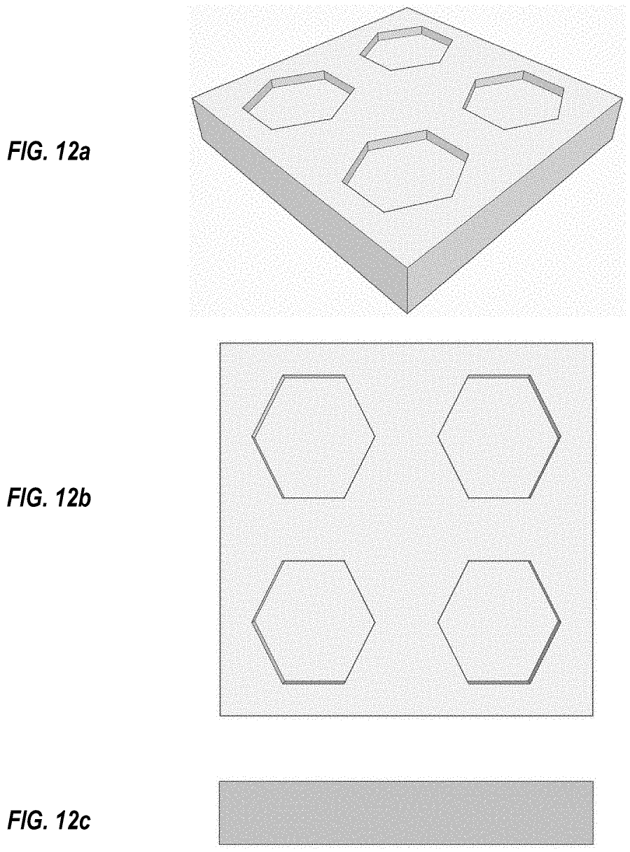

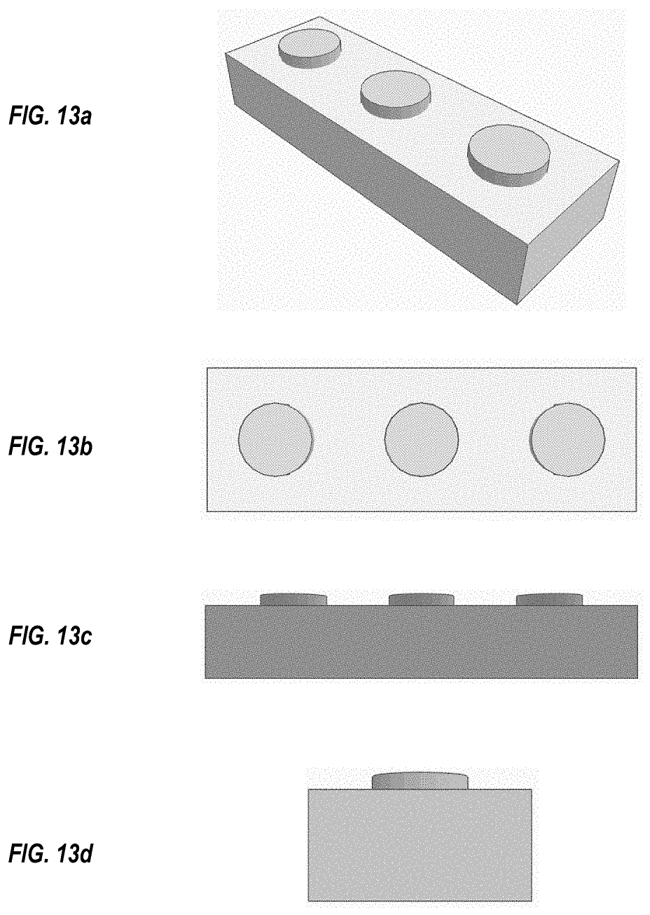

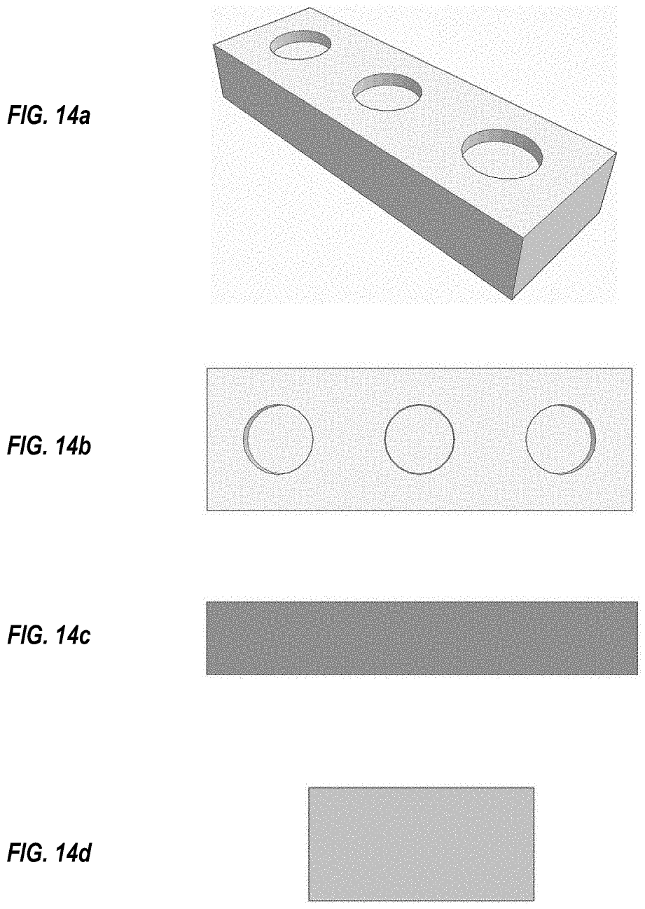

FIGS. 11a-11c depict an embodiment in which a square-shaped paver includes hexagonal protrusions, and FIGS. 12a-12c depict an embodiment in which a square-shaped paver included hexagonal recesses. FIGS. 13a-13d depict an embodiment in which a rectangular paver includes circular column-shaped protrusions, and FIGS. 14a-14d depict an embodiment in which a rectangular paver includes circular column-shaped recesses. Embodiments of the disclosed technology are not limited to any particular shape of paver. Instead, a paver may be of any desired shape, such as a circle, triangle, square, rectangle, trapezoid, parallelogram, pentagon, hexagon, heptagon, octagon, any other polygon, or any irregular shape. Moreover, a paver according to the present disclosure can be made from any desired material, such as concrete, stone (e.g., limestone, tavertine, bluestone, basalt, sandstone, granite, marble), clay (e.g., brick, ceramic, porcelain), wood, metal (e.g., steel, aluminum), plastic (e.g., polyvinyl chloride (PVC), nylon), or any other material that can form a flooring.

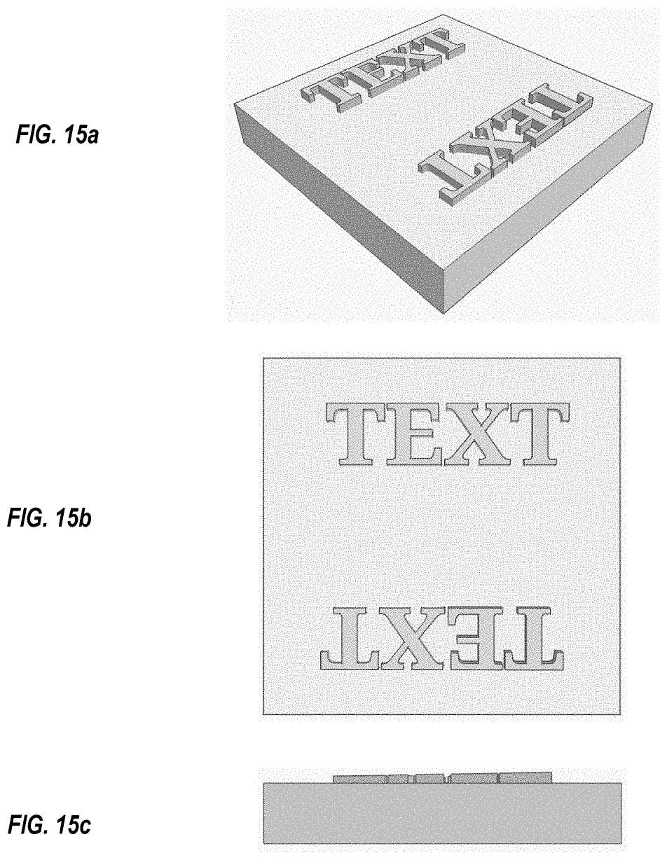

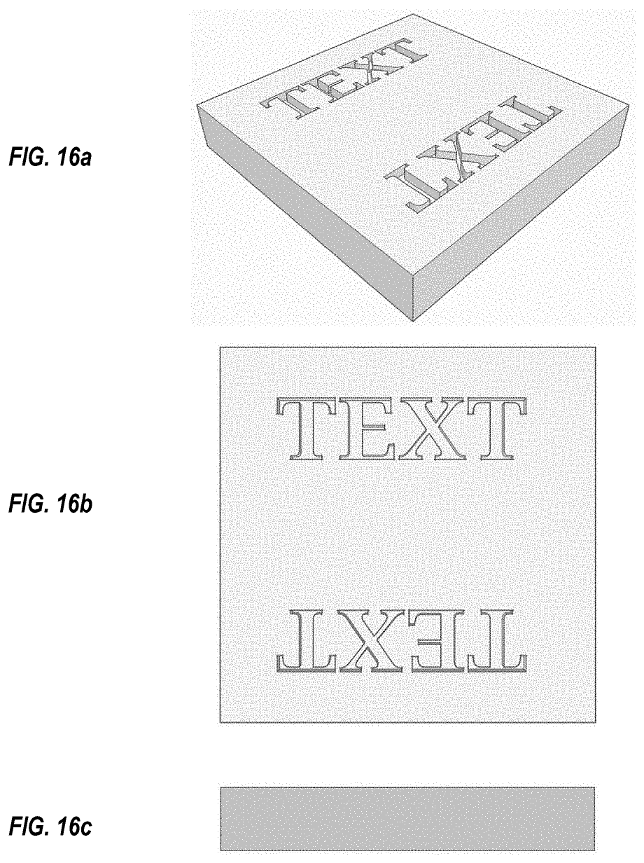

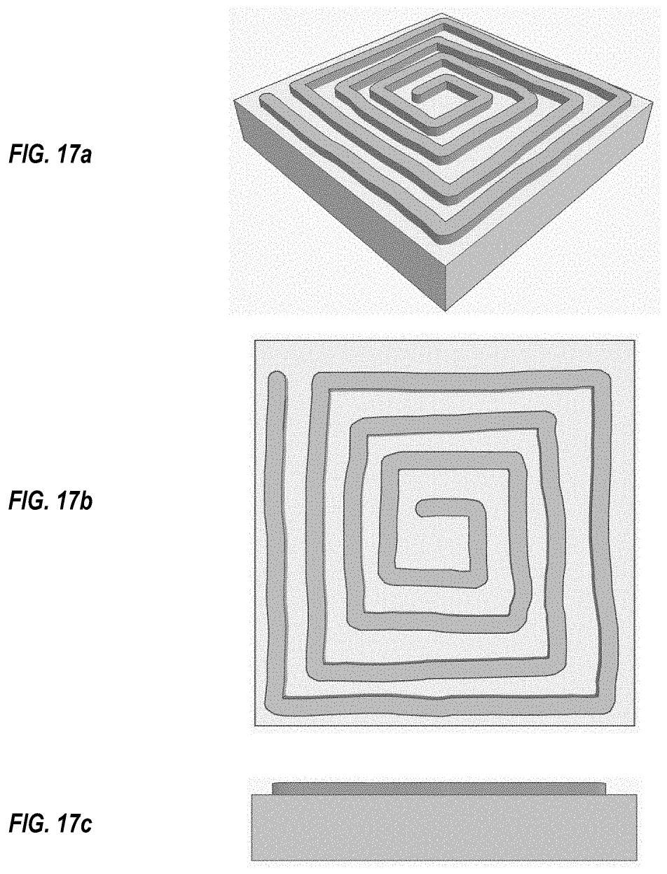

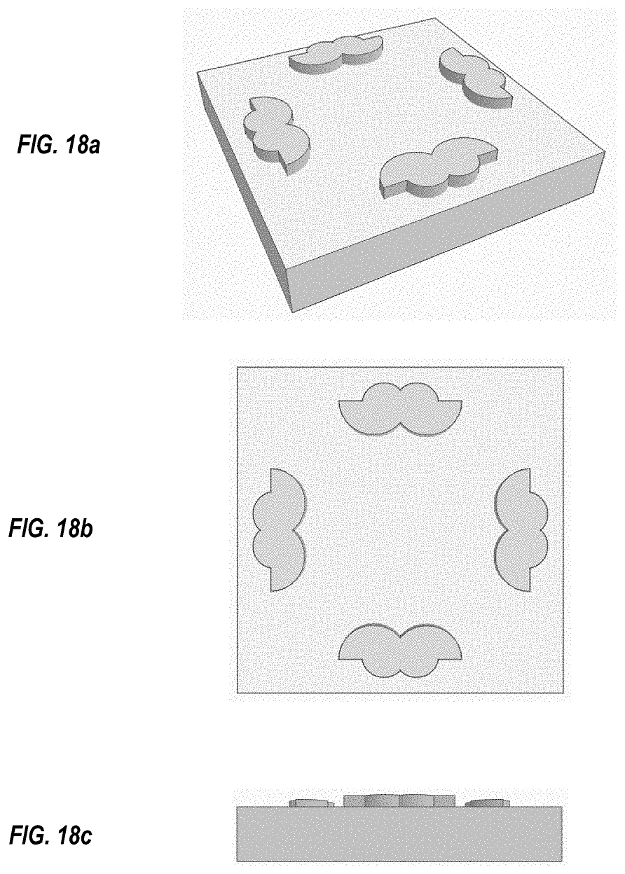

As discussed above, some embodiment may include gripping structures having an irregularly shaped cross-section. FIGS. 15a-15c depict a paver including two instances of protruding text, with either protrusion being rotated 180° with respect to the opposite protrusion, and FIGS. 16a-16c depict a similar embodiment in which the text is recessed. FIGS. 17a-17c depict a paver including a single gripping structure: a square-shaped spiral protrusion. FIGS. 18a-18c depict an embodiment including four mustache-shaped protrusions, with each protrusion being rotate 90° with respect to either adjacent protrusion.

Certain embodiments of the present disclosure include methods for manufacturing various embodiments of the disclosed pavers. According to some embodiments, a mold is created wherein the mold includes a negative space corresponding to the paver tile. To create a mold for a paver having protruding gripping structures, the bottom of the negative space further extends, creating an additional negative space corresponding to each desired protrusion. To create a mold for a paver having recessed gripping structure, the bottom of the negative space includes a protrusion, which corresponds to the desired recess of the paver. In some embodiments, the mold includes a top or lid, while in other embodiments a top or lid is not included. Regardless, subsequent to creating the mold, a desired material is introduced into the mold. In some embodiments, the introduced material is a fluid or a semi-fluid. In some embodiments, the introduced material is malleable. Subsequent to introducing the material, the material is allowed or caused to dry, cure, or otherwise harden. In certain embodiments, the material is left in the mold for a predetermined amount of time. In some embodiments, the material is baked at a predetermined temperature for a predetermined amount of time while the material is in the mold. After the material is hardened, the hardened material is removed from the mold as a paver tile including one or more gripping structures.

In some embodiments, a paver including one or more gripping structures can be created by carving or chiseling the desired paver from a portion of material. For example, a paver can be chiseled from a block of stone such that one or more protrusions extend from the bottom surface of the paver and/or one or more recesses extend into the bottom surface of the paver. In certain embodiments, a paver may be created via additive manufacturing techniques (e.g., 3D printing). That is, in some embodiments, layers of material may be iteratively stacked to create a paver of any desired shape including one or more gripping structures of any desired size, shape, position, and arrangement.

Certain embodiments of the present disclosure include methods for using or installing various embodiments of the disclosed pavers. As described above, pavers can be used to create a flooring, such as an exterior flooring. Non-limiting examples of exterior floorings are patios, sidewalks, driveways, alleys, or other paths, drives, or walkways. In some embodiments, a foundation is created. A foundation may include an area of flattened earth, concrete, asphalt, or any other material. In some embodiments, the foundation is a preexisting area of flooring, such as a sidewalk, driveway, alley, or another path, drive, or walkway.

According to some embodiments, adhesive is added to the foundation, and one or more pavers is laid upon the adhesive. In some embodiments, adhesive is added to the entirety of the foundation, and pavers are then laid upon the adhesive. In certain embodiments, adhesive and one or more pavers are iteratively added to the foundation. That is, in some embodiments, adhesive may be added to only a portion of the foundation corresponding to a desired number of pavers, and the desired number of pavers may then be laid upon the added adhesive. Subsequently, additional adhesive and pavers may then be added. In some embodiments, the adhesive may be allowed or caused to cure or harden such that the pavers are secured or affixed in place.

In certain embodiments, pavers according to the present disclosure may be used only along outer borders of an area, and traditional pavers may be used for the interior portions of the area. In such embodiments, adhesive may be added along the outer edges of the area, and pavers according to the present disclosure may be laid upon the adhesive. In some embodiments, the adhesive may be allowed or caused to cure or harden such that the pavers are secured or affixed in place. Traditional pavers may be laid in the interior portion of the area. In some embodiments, the traditional pavers may be laid in the interior portion of the area subsequent to the adhesive being allowed or caused to cure or harden such that the pavers are secured or affixed in place, such as when a wet adhesive (e.g., an adhesive premixed with water prior to application) is used. In some embodiments, the traditional pavers may be laid in the interior portion of the area prior to the adhesive being allowed or caused to cure or harden (or fully cure or harden), such as when a dry adhesive (e.g., an adhesive not premixed with water prior to application) is used. In some embodiments, some or all of the traditional pavers may be laid upon adhesive, and in some embodiments some or all of the traditional pavers may be laid directly upon the foundation without adhesive. For embodiments in which the traditional pavers are laid upon adhesive, the corresponding adhesive may be allowed or caused to cure or harden.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

1. A paver comprising:
a substantially flat top surface;
a bottom surface including one or more regions of the bottom surface that extend outwardly from a substantially planar surface to form one or more respective rigid protrusions, the bottom surface having an interior region and a perimeter region (i) surrounding the interior region and (ii) adjacent an outer edge of the bottom surface, wherein at least one of the one or more rigid protrusions is located within the interior region; and
one or more side surfaces connecting the top surface to the bottom surface.

2. The paver of claim 1, wherein the one or more rigid protrusions are integral with the bottom surface.

3. The paver of claim 2, wherein at least one rigid protrusion of the one or more rigid protrusions has a circular or polygonal cross-section.

4. The paver of claim 2, wherein at least one rigid protrusion of the one or more rigid protrusions is hemispherical or conical.

5. The paver of claim 2, wherein at least one rigid protrusion of the one or more rigid protrusions has a cross-section indicative of a silhouette of a person, character, animal, plant, or object.

6. The paver of claim 2, wherein at least one rigid protrusion of the one or more rigid protrusions is indicative of text.

7. The paver of claim 2, wherein at least one rigid protrusion of the one or more rigid protrusions has a non-constant height.

8. The paver of claim 2, wherein the one or more rigid protrusions comprises a first rigid protrusion having a first height and a second rigid protrusion having a second height equal to the first height.

9. The paver of claim 2, wherein the one or more rigid protrusions comprises a first rigid protrusion having a first height and a second rigid protrusion having a second height different than the first height.

10. The paver of claim 2, wherein the one or more rigid protrusions comprises a first rigid protrusion having a first rotational orientation and a second rigid protrusion having a second rotational orientation, the second rotational orientation being different than the first rotational orientation.

11. The paver of claim 2, wherein the one or more rigid protrusions comprises a plurality of rigid protrusions arranged in a grid on the bottom surface.

12. The paver of claim 2, wherein the one or more rigid protrusions comprises a first plurality of rigid protrusions arranged in a first grid and a second plurality of rigid protrusions arranged in a second grid, the second grid being offset from the first grid.

13. The paver of claim 1, wherein the paver comprises concrete, clay, brick, or ceramic.

14. A method for manufacturing a paver having one or more protrusions, the method comprising:
providing a mold defining a negative space and having a substantially flat bottom surface, the negative space including a paver volume and at least one protrusion volume, each of the at least one protrusion volumes extending beyond the substantially flat bottom surface and being in direct fluid communication with the paver volume;
introducing a material into the mold;
allowing or causing the material to harden within the mold; and
removing the hardened material from the mold to produce the paver having the one or more protrusions.

15. A method comprising:
providing a foundation;
applying an adhesive to the foundation;
laying a plurality of gripping pavers on the adhesive, each gripping paver of the plurality of gripping pavers including:
a substantially flat top surface,
a bottom surface comprising one or more integral protrusions, and
one or more side surfaces; and
allowing or causing the adhesive to dry or cure.

16. The method of claim 15, wherein the foundation is a preexisting flooring.

17. The method of claim 15, wherein the laying the plurality of gripping pavers comprises laying the plurality of gripping pavers along an external edge of a predetermined area, the method further comprising laying non-gripping pavers in an internal portion of the predetermined area, the non-gripping pavers including a substantially flat bottom surface.

18. The method of claim 15, wherein at least one of the one or more integral protrusions is hemispherical or conical or has a cross-section that is circular or polygonal.

19. The method of claim 18, wherein the one or more integral protrusions comprises a plurality of integral protrusions is arranged in a grid.

20. The paver of claim 1, wherein the top surface, bottom surface, and one or more side surfaces form a body of the paver, the body and the one or more protrusions sharing a common material composition.
